(19) United States
(12) Patent Application Publication
(10) Pub. No.: US 2015/0234656 A1
(43) Pub. Date: Aug. 20, 2015

(54) VECTOR PROCESSOR, INFORMATION PROCESSING APPARATUS, AND OVERTAKING CONTROL METHOD

(71) Applicant: NEC Corporation, Tokyo (JP)

(72) Inventors: Hiroki ASANO, Tokyo (JP); Yasuo ISHII, Tokyo (JP)

(73) Assignee: NEC Corporation

(21) Appl. No.: 14/624,795

(22) Filed: Feb. 18, 2015

(30) Foreign Application Priority Data
Feb. 20, 2014 (JP) 2014-030748

(51) Int. Cl. G06F 9/30

(52) U.S. Cl. CPC G06F 9/30043; G06F 9/30036

(57) ABSTRACT

The frequency by which an overtaking process is performed is improved, so that memory access performance is improved. A vector processor 1000 includes an element check unit 123 that calculates a state of bits of a preset number of digits from a least significant digit of an address of a memory, which is accessed by a load instruction or a store instruction, as an element check result, and an overtaking determination unit 122 that performs overtaking determination of a load instruction for a store instruction preceding to the load instruction on the basis of the element check result.

This application is based upon and claims the benefit of priority from Japanese Patent Application No. 2014-030748, filed on Feb. 20, 2014, the disclosure of which is incorporated herein in its entirety by reference.

### TECHNICAL FIELD

The present invention relates to an overtaking process for speeding up memory access of a computer.

### BACKGROUND ART

When accessing a memory in a computer, an operation of a store instruction is generally slower than an operation of a load instruction. When there occurs a state in which a faster load instruction waits for a slower store instruction, the overall memory access performance of the computer is degraded.

As a method of speeding up the instruction processing of a computer, a vector processing method is known. When accessing a memory by a vector instruction, an overtaking process is performed in order to prevent performance degradation due to the situation that a load instruction waits for a store instruction. The overtaking process is performed by executing a subsequent load instruction earlier than a preceding store instruction when addresses to be accessed do not overlap each other.

A vector instruction control circuit disclosed in Patent Literature 1 (Japanese Laid-open Patent Publication No. 2012-150634) determines the overlap of addresses to be accessed with respect to a list vector instruction having a list address on the basis of a maximum address and a minimum address in the list address. In this way, the vector instruction control circuit disclosed in Patent Literature 1 performs the determination of an overtaking process at a high speed without determining the overlap of addresses with respect to all addresses in the list address.

A vector computer disclosed in Patent Literature 2 (Japanese Laid-open Patent Publication No. 2011-118743) calculates an access range of an instruction in a vector gather instruction or a vector scatter instruction on the basis of maximum values and minimum values among vector elements. The vector computer disclosed in Patent Literature 2 performs the determination of an overtaking process on the basis of the calculated access range.

### SUMMARY

### Technical Problem

In the aforementioned vector instruction control circuit disclosed in Patent Literature 1, there is a problem that, when the list address is not a continuous address, the overtaking process may be determined not to be possible although addresses do not overlap each other. That is, when an instruction to be subjected to the overtaking process accesses a memory of an address between a maximum address and a minimum address in the list address, even though addresses to be accessed do not overlap each other, the overtaking process is determined not to be possible.

Also in the aforementioned vector computer disclosed in Patent Literature 2, when addresses to be accessed by the vector gather instruction or the vector scatter instruction are not continuous, the same problems occur.

Accordingly, an object of the present invention is to provide a technology for solving or reducing the aforementioned problems.

### Solution to Problem

A vector processor according to one aspect of the present invention to achieve the above-mentioned object includes an element check unit that calculates a state of bits of a predetermined number of digits from a least significant digit of an address of a memory, which is accessed by a load instruction or a store instruction, as an element check result, and an overtaking determination unit that performs overtaking determination of a load instruction for a store instruction preceding to the load instruction on the basis of the element check result.

An information processing apparatus according to one aspect of the present invention to achieve the above-mentioned object includes the aforementioned vector processor.

An overtaking control method according to one aspect of the present invention to achieve the above-mentioned object includes calculating a state of bits of a predetermined number of digits from a least significant digit of an address of a memory, which is accessed by a load instruction or a store instruction, as an element check result, and performing overtaking determination of a load instruction for a store instruction preceding to the load instruction on the basis of the element check result.

### Advantageous Effects of Invention

With the present invention, it is possible to improve memory access performance by improving the frequency by which an overtaking process is performed.

### BRIEF DESCRIPTION OF THE DRAWINGS

Exemplary features and advantages of the present invention will become apparent from the following detailed description when taken with the accompanying drawings in which:

FIG. 1 is a block structure diagram illustrating a structure of CPU (Central Processing Unit) provided in an information processing apparatus according to a first exemplary embodiment of the present invention;

FIG. 2 is a block diagram illustrating an operation of an element check unit 123;

FIG. 3 is a block diagram illustrating another operation of an element check unit 123;

FIG. 4 is a diagram illustrating a buffer 1221 provided in an overtaking determination unit 122; and

FIG. 5 is a block structure diagram illustrating a structure of a vector processor according to a second exemplary embodiment of the present invention.

### EXEMPLARY EMBODIMENT

Next, exemplary embodiments of the present invention will be described in detail with reference to the accompanying drawings.

### First Exemplary Embodiment

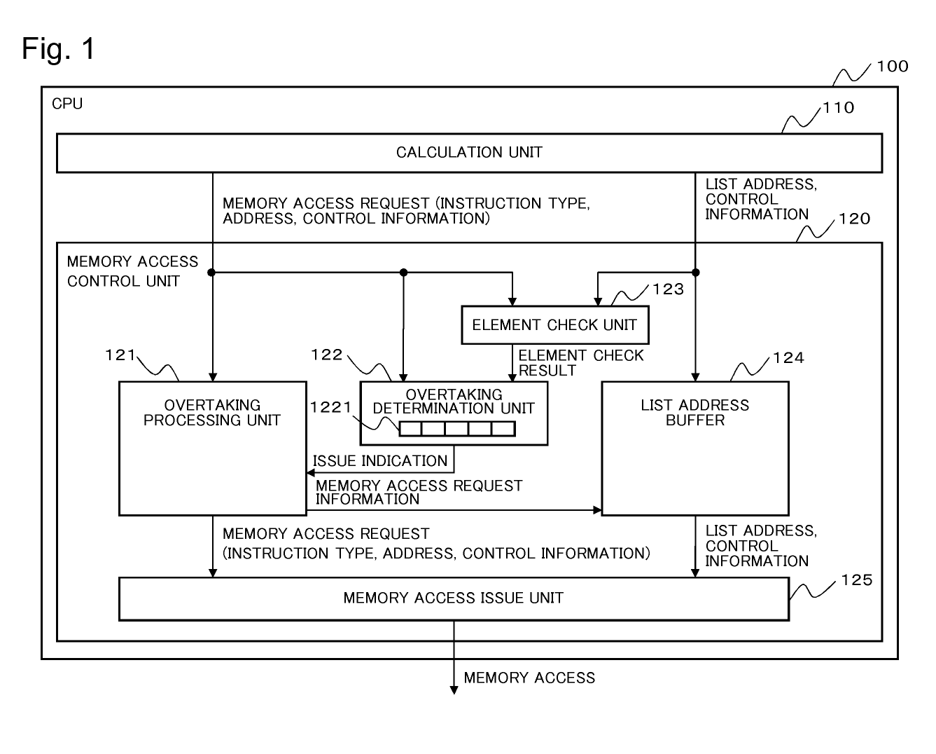

FIG. 1 is a block structure diagram illustrating a structure of a CPU (Central Processing Unit) 100 provided in an information processing apparatus according to a first exemplary embodiment of the present invention. The CPU 100 according to the first exemplary embodiment of the present invention includes a calculation unit 110 and a memory access control unit 120. The CPU 100 has an instruction set including a memory access instruction, which can access a plurality of pieces of element data by one instruction, such as a vector load instruction and a vector gather instruction. A processor, like the CPU 100, having an instruction set, which includes a memory access instruction capable of accessing a plurality of pieces of element data by one instruction, is also called a vector processor.

The calculation unit 110 includes a register (not illustrated), controls an instruction, and performs calculation by using data stored in the register. Furthermore, the calculation unit 110 issues a memory access request to the memory access control unit 120 in order to load data to be used in calculation into the register or store a calculation result in a memory. The memory access request is a packet including an instruction type of the memory access request, an address of an access destination, other pieces of control information, and the like. When the instruction type included in the memory access request is a vector instruction that performs list access, the calculation unit 110 transmits a list address and control information of the list address to the memory access control unit 120, separately from the memory access request. In the list access, a plurality of addresses are designated to be accessed. The list address, for example, is a signal or a data value including designation of a plurality of addresses that are designated as addresses of an access destination in the vector instruction to perform the list access.

The memory access control unit 120 includes an overtaking processing unit 121, an overtaking determination unit 122, an element check unit 123, a list address buffer 124, and a memory access issue unit 125.

The overtaking processing unit 121 receives the memory access request from the calculation unit 110. Then, on the basis of an indication from the overtaking determination unit 122, the overtaking processing unit 121 issues a memory access request toward the memory access issue unit 125. Furthermore, the overtaking processing unit 121 transmits information (that is, memory access request information) on the issued memory access request to the list address buffer 124. The memory access request information, for example, is information including an instruction ID (IDentification), as will be described later.

The overtaking determination unit 122 includes a buffer 1221. The overtaking determination unit 122 stores, in an entry of the buffer 1221, the memory access request issued from the calculation unit 110 and an element check result that is transmitted from the element check unit 123. The element check result, for example, is a data value representing a determination result of the element check unit 123 regarding whether there is a bias in an address issued from the calculation unit 110, as will be described later. Next, the overtaking determination unit 122 determines whether the memory access request stored in the buffer 1221 is able to overtake a preceding memory access request (that is, performs overtaking determination). The overtaking determination unit 122 may perform the overtaking determination by examining a dependency relation of addresses to be accessed by the memory access request stored in the buffer 1221. On the basis of a result of the overtaking determination, the overtaking determination unit 122 rearranges entries of the buffer 1221. Then, on the basis of the rearranged entries of the buffer 1221, the overtaking determination unit 122 transmits information indicating a memory access request to be subsequently issued to the overtaking processing unit 121.

The element check unit 123 determines whether there is a bias in the address issued from the calculation unit 110. Then, the element check unit 123 transmits a result of the determination regarding whether there is a bias in the address issued from the calculation unit 110 to the overtaking determination unit 122 as the element check result.

The list address buffer 124 is a buffer that stores the list address issued from the calculation unit 110. The list address buffer 124 issues, toward the memory access issue unit 125, a list address associated with the memory access request information transmitted from the overtaking processing unit 121. The list address associated with the memory access request information is, for example, a list address including addresses of a plurality of access destinations, which are accessed by the memory access request indicated by the memory access request information.

The memory access issue unit 125 receives the memory access request from the overtaking processing unit 121. Furthermore, when the instruction type included in the memory access request is the vector instruction to perform the list access, the memory access issue unit 125 receives the list address from the list address buffer 124. Then, the memory access issue unit 125 modifies the memory access request into a form suitable for being received in a memory, and actually issues a modified memory access request.

Hereinafter, with reference to FIG. 1, an operation of the information processing apparatus according to the first exemplary embodiment will be described. First, the calculation unit 110 decodes an instruction fetched by the CPU 100 and performs processing according to the type of the instruction. When the fetched instruction is an instruction to access a memory, the calculation unit 110 issues a memory access request (including an instruction type, an address, and control information) for the memory access control unit 120. The control information included in the memory access request may include all information other than addresses necessary for executing each instruction. For example, the control information includes an instruction ID uniquely assigned to each instruction being executed.

When the fetched instruction is an instruction to access a plurality of pieces of data held at a constant address interval (that is, a distance) from a designated address, the control information includes distance information, a vector length (that is, the number of elements to be accessed), and the like. Such an instruction, for example, is a vector load instruction to perform reading from a memory, a vector store instruction to perform writing to a memory, and the like.

Furthermore, when the fetched instruction is an instruction to perform the list access, the calculation unit 110 issues a list address and control information of the list address toward the memory access control unit 120, separately from a memory access request. The instruction that performs the list access, for example, is a vector gather instruction to perform reading from a memory, a vector scatter instruction to perform writing to a memory, and the like. In the following description, the instruction to perform the list access is also referred to as a list access instruction.

The control information of the list address includes a V bit indicating that addresses are valid, an instruction ID indicating an associated instruction, a S bit indicating that a head address accessed by the associated instruction is included, and an E bit indicating that the rearmost address is included. The associated instruction indicated by the instruction ID included in the control information of the list address is a memory access request having access destinations at least a part of addresses of which is the list address. In general, as addresses of the vector instruction to perform the list access, a plurality of addresses can be issued in one cycle. For example, it is assumed that four addresses can be simultaneously issued as one list address in one cycle. In this case, in a list access instruction having a vector length of 16, the S bit is 1 when initial four addresses are transmitted and the E bit is 1 in the fourth cycle.

In other words, when the vector length of the list access instruction is 16, a list address including four addresses is issued for the list access instruction four times. Since four addresses are transmitted in one cycle (that is, one list address is issued), four list addresses are issued in four cycles. When addresses are transmitted from a head address by four addresses, the head address is transmitted in the first cycle. The rearmost address is transmitted in the fourth cycle. In addition, the head address, for example, is an address that is initially designated in the list address. The head address is not always the smallest address. The rearmost address, for example, is an address that is finally designated in the list address. The rearmost address is not always the largest address.

In the present exemplary embodiment, a value of the V bit is a value representing affirmation or a value representing negation, a value of the S bit is the value representing affirmation or the value representing negation, and a value of the E bit is the value representing affirmation or the value representing negation. In the following description, the value representing affirmation is 1, for example. The value representing negation is 0, for example. The value representing affirmation and the value representing negation are not limited to the above example. The value representing affirmation, which is set as the values of the V bit, the S bit, and the E bit, is also referred to as a value indicating lighting or a value indicating ON.

When the value representing affirmation is set in the V bit, an instruction ID, a value of the S bit, a value of the E bit, address 0, address 1, address 2, and address 3 are valid. When the value representing affirmation is set in the S bit, addresses from the address 0 to the address 3 include a head address of addresses to be accessed by an instruction to perform list access on a plurality of addresses including the addresses from the address 0 to the address 3. When the value representing affirmation is set in the E bit, the addresses from the address 0 to the address 3 include the rearmost address of the addresses to be accessed by the instruction to perform the list access on the plurality of addresses including the addresses from the address 0 to the address 3.

In the information processing apparatus according to the first exemplary embodiment, it is assumed that list addresses for one instruction are continuously issued with no space. That is, in the present exemplary embodiment, list addresses as access destinations of the same instruction are issued in a continuous cycle.

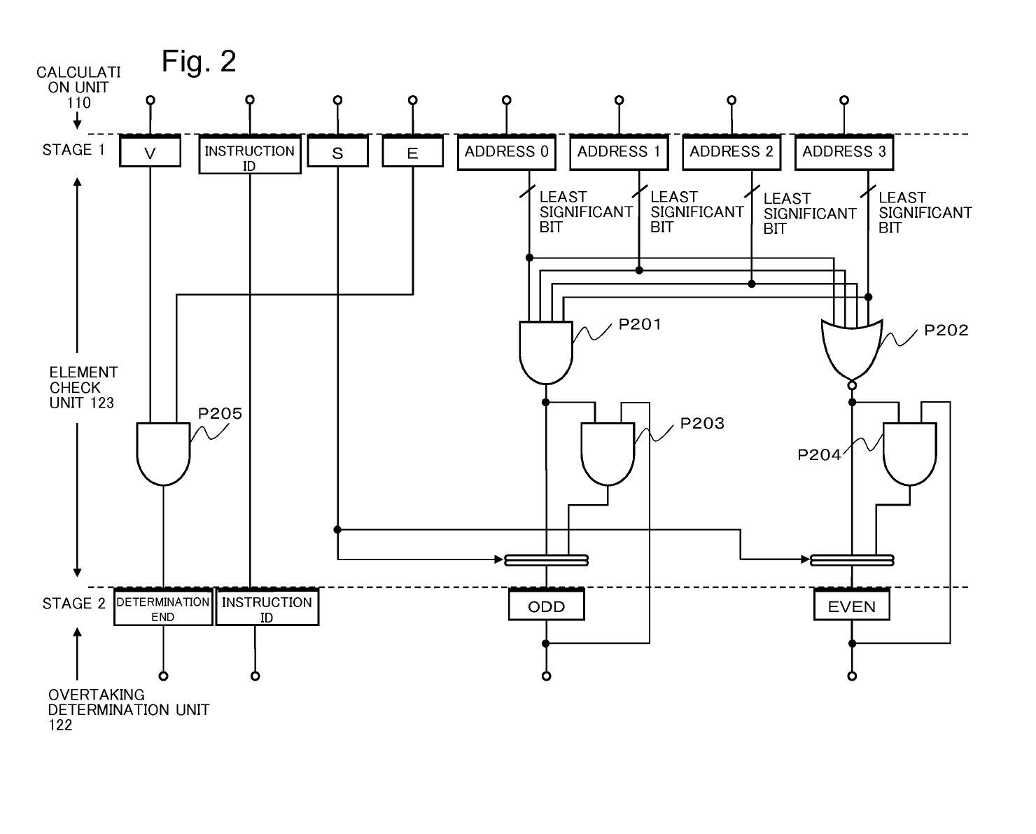

FIG. 2 is a block diagram illustrating an operation of the element check unit 123. Hereinafter, with reference to FIG. 2, a description will be provided for an operation which the element check unit 123 performs when an instruction to perform the list access, such as the vector gather instruction and the vector scatter instruction, is issued. The element check unit 123 performs an operation illustrated in FIG. 2 on the basis of the list address issued from the calculation unit 110 and the control information of the list address. Moreover, FIG. 2 schematically illustrates a circuit that determines the presence or absence of a bias in addresses to be accessed when the issued instruction is an instruction to perform the list access, such as the vector gather instruction and the vector scatter instruction. At least a part of the element check unit 123 may also be realized by the circuit schematically illustrated in FIG. 2 or a circuit that performs the same operation.

The following description will be provided for a method of determining the presence or absence of a bias in addresses to be accessed by examining whether only odd addresses or even addresses are accessed. The element check unit 123 checks the state of the least significant bit of an address, thereby examining whether only odd addresses or even addresses is accessed. The odd addresses are addresses having the least significant bits of 1 represented by binary numbers. The even addresses are addresses having the least significant bits of 0 represented by binary numbers. When only the odd addresses or only the even addresses are accessed, the element check unit 123 determines that there is a bias in the addresses to be accessed. Otherwise, the element check unit 123 determines that there is no bias in the addresses to be accessed. In addition, in the description of each exemplary embodiment of the present invention, “accessing the odd addresses” represents access to areas of a memory represented by the odd addresses. Similarly, “accessing the even addresses” represents access to areas of a memory represented by the even addresses. However, an object to be checked is not limited to the least significant bit. In addition, the least significant bits in the present invention indicate the least significant bits in accessed units.

The description of the right side of “stage 1” and “stage 2” of FIG. 2 indicates information held in each clock cycle and operations for the information. Furthermore, the description of “V”, “instruction ID”, “S”, “E”, “address 0”, “address 1”, “address 2”, “address 3”, “determination end”, “ODD”, and “EVEN” enclosed in rectangles indicate flip-flops that store these information. In other words, a rectangle enclosing a character or a character string represents a flip-flop that stores information represented by the character or the character string. In the following description, a flip-flop represented by a rectangle enclosing a “character or character string” will be written as a flip-flop “character or character string”, or a flip-flop of a “character or character string”.

For example, the value of the V bit is stored in the “V” flip-flop represented by the rectangle enclosing the “V”. The instruction ID is stored in the “instruction ID” flip-flop represented by the rectangle enclosing the “instruction ID”. The value of the S bit is stored in the “S” flip-flop represented by the rectangle enclosing the “S”. The value of the E bit is stored in the “E” flip-flop represented by the rectangle enclosing the “E”. The “address 0” serving as an initial address included in the list address is stored in the “address 0” flip-flop represented by the rectangle enclosing the “address 0”. The “address 1” serving as a second address included in the list address is stored in the “address 1” flip-flop represented by the rectangle enclosing the “address 1”. The “address 2” serving as a third address included in the list address is stored in the “address 2” flip-flop represented by the rectangle enclosing the “address 2”. The “address 3” serving as a fourth address included in the list address is stored in the “address 3” flip-flop represented by the rectangle enclosing the “address 3”. A value representing whether determination for a list address issued for one instruction has been ended is stored in the “determination end” flip-flop represented by the rectangle enclosing the “determination end”.

A value “1” is stored in the “ODD” flip-flop represented by the rectangle enclosing the “ODD” when addresses to be determined are odd addresses. Furthermore, a value “1” is stored in the “EVEN” flip-flop represented by the rectangle enclosing the “EVEN” when addresses to be determined are even addresses.

The list address issued from the calculation unit 110 and the control information of the list address are stored in the flip-flops of the stage 1. In the example illustrated in FIG. 2, the flip-flops of the stage 1 are flip-flops of the “V”, the “instruction ID”, the “S”, the “E”, the “address 0”, the “address 1”, the “address 2”, and the “address 3”. The control information of the list address is stored in the flip-flops of the “V”, the “instruction ID”, the “S”, and the “E”. The list address is stored in the flip-flops of the “address 0”, the “address 1”, the “address 2”, and the “address 3”. Then, in the stage 1, by performing an AND operation of the least significant bits of the “address 0”, the “address 1”, the “address 2”, and the “address 3” (processing P201), it is determined whether these addresses are all odd addresses. Furthermore, by performing a NOR operation of the least significant bits of the “address 0”, the “address 1”, the “address 2”, and the “address 3” (processing P202), it is determined whether these addresses are all even addresses.

In other words, the element check unit 123 stores the list address and the control information of the list address received from the calculation unit 110 in the flip-flops of the aforementioned stage 1. In detail, the element check unit 123 stores the “V bit”, the “instruction ID”, the “S bit”, and the “E bit” included in the control information of the list address in the flip-flops of the “V”, the “instruction ID”, the “S”, and the “E”, respectively. The element check unit 123 sequentially stores four addresses included in the list address in the flip-flops of the “address 0”, the “address 1”, the “address 2”, and the “address 3”.

The element check unit 123 calculates an AND of the least significant bits of the “address 0”, the “address 1”, the “address 2”, and the “address 3”, thereby determining whether these addresses are all odd addresses. When the AND of the least significant bits of the “address 0”, the “address 1”, the “address 2”, and the “address 3” is 1, the “address 0”, the “address 1”, the “address 2”, and the “address 3” are all odd addresses. When the AND of the least significant bits of the “address 0”, the “address 1”, the “address 2”, and the “address 3” is 0, at least one of the “address 0”, the “address 1”, the “address 2”, and the “address 3” is an even address.

The element check unit 123 calculates a NOR of the least significant bits of the “address 0”, the “address 1”, the “address 2”, and the “address 3”, thereby determining whether these addresses are all even addresses. When the NOR of the least significant bits of the “address 0”, the “address 1”, the “address 2”, and the “address 3” is 1, the “address 0”, the “address 1”, the “address 2”, and the “address 3” are all even addresses. When the NOR of the least significant bits of the “address 0”, the “address 1”, the “address 2”, and the “address 3” is 0, at least one of the “address 0”, the “address 1”, the “address 2”, and the “address 3” is an odd address.

In the following description, for example, storing a value representing affirmation in the flip-flop of the “S” as the value of the S bit will be written as setting a value representing lighting (ON) in the “S” bit. Storing a value representing negation in the flip-flop of the “S” as the value of the S bit will be written as setting a value representing extinction (OFF) in the “S” bit. Furthermore, the fact that the value representing affirmation has been stored in the flip-flop of the “S” as the value of the S bit will be written that the “S” bit is lighted (ON). The fact that the value representing negation has been stored in the flip-flop of the “S” as the value of the S bit will be written that the “S” bit is extinguished (OFF). The V bit and the E bit will also be written similarly to the S bit.

When an initial address of addresses to be accessed is included in an issued list address, the calculation unit 110 sets, for example, the value representing lighting (ON) in the “S” bit. At this time, when the “S” bit of the stage 1 is lighted (ON), the “S” bit represents that a head address of a plurality of addresses to be accessed by a certain instruction is included in the list address. That is, in this case, addresses stored in the flip-flops form the “address 0” to the “address 3” are addresses included in a list address transmitted in initial transmission among list addresses of the instruction. When the “S” bit of the stage 1 is lighted, the result of the determination performed in the stage 1 regarding whether the addresses are all odd addresses is stored in the “ODD” flip-flop of the stage 2. That is, the AND (processing P201) of the least significant bits of the “address 0”, the “address 1”, the “address 2”, and the “address 3” of the stage 1 is stored in the “ODD” flip-flop of the stage 2.

In other words, when the “S” bit of the stage 1 is lighted, the element check unit 123 stores the result of the determination performed in the stage 1 regarding whether the addresses are all odd addresses in the “ODD” flip-flop of the stage 2. That is, the element check unit 123 stores the AND of the least significant bits of the “address 0”, the “address 1”, the “address 2”, and the “address 3” of the stage 1 in the “ODD” flip-flop of the stage 2.

Similarly, when the “S” bit of the stage 1 is lighted (ON), the result of the determination performed in the stage 1 regarding whether the addresses are all even addresses is stored in the “EVEN” flip-flop of the stage 2. That is, the NOR (processing P202) of the least significant bits of the “address 0”, the “address 1”, the “address 2”, and the “address 3” of the stage 1 is stored in the “EVEN” flip-flop of the stage 2.

In other words, when the “S” bit of the stage 1 is lighted, the element check unit 123 stores the result of the determination performed in the stage 1 regarding whether the addresses are all even addresses in the “EVEN” flip-flop of the stage 2. That is, the element check unit 123 stores the NOR of the least significant bits of the “address 0”, the “address 1”, the “address 2”, and the “address 3” of the stage 1 in the “EVEN” flip-flop of the stage 2.

When the initial address of the addresses to be accessed is not included in the issued list address, the calculation unit 110 sets, for example, the value representing extinction (OFF) in the “S” bit. At this time, when the “S” bit of the stage 1 is extinguished (OFF), the “S” bit represents that a head address of a plurality of addresses to be accessed by a certain instruction is included in the list address. That is, in this case, addresses stored in the flip-flops form the “address 0” to the “address 3” are included in a list address transmitted in transmission (that is, second and subsequent transmission), other than initial transmission, among list addresses of the instruction. When the “S” bit of the stage 1 is extinguished, an AND (processing P203) of the result (processing P201) of the determination performed in the stage 1 regarding whether the addresses are all odd addresses and the value of the “ODD” flip-flop is stored in the “ODD” flip-flop of the stage 2. Similarly, when the “S” bit of the stage 1 is extinguished, an AND (processing P204) of the result (processing P202) of the determination performed in the stage 1 regarding whether the addresses are all even addresses and the value of the “EVEN” flip-flop is stored in the “EVEN” flip-flop of the stage 2.

In the following description, the addresses stored in the flip-flops form the “address 0” to the “address 3” will be written as object addresses. When the “S” bit of the stage 1 is extinguished, these object addresses are addresses transmitted in second and subsequent transmission for an instruction (hereinafter, referred to as an object instruction) in which the object addresses are at least a part of a plurality of addresses serving as an access destination. Furthermore, a result of determination, which determines whether all addresses transmitted from the calculation unit 110 before the object addresses are transmitted and included in the list address of the object instruction are odd addresses, has been stored in the “ODD” flip-flop of the stage 2. A result of determination, which determines whether all addresses transmitted from the calculation unit 110 before the object addresses are transmitted and included in the list address of the object instruction are even addresses, has been stored in the “EVEN” flip-flop of the stage 2.

When the “S” bit of the stage 1 is extinguished, the element check unit 123 stores, in the “ODD” flip-flop, an AND of a result of determination regarding whether the object addresses are all odd addresses and the value of the “ODD” flip-flop. The element check unit 123 stores, in the “EVEN” flip-flop, an AND of a result of determination regarding whether the object addresses are all even addresses and the value of the “EVEN” flip-flop. The AND stored in the “ODD” flip-flop by the element check unit 123 represents whether the object addresses and addresses, which have been transmitted from the calculation unit 110 before the object addresses and are accessed by the object instruction, are all odd addresses. The AND stored in the “EVEN” flip-flop by the element check unit 123 represents whether the object addresses and addresses, which have been transmitted from the calculation unit 110 before the object addresses and are accessed by the object instruction, are all even addresses.

The value of the “instruction ID” flip-flop of the stage 1 is stored in the “instruction ID” flip-flop of the stage 2 as is. Furthermore, an AND (processing P205) of the “E” bit and the “V” bit of the stage 1 is stored in the “determination end” flip-flop of the stage 2.

In other words, the element check unit 123 stores the value of the “instruction ID” flip-flop of the stage 1 in the “instruction ID” flip-flop of the stage 2 as is. Furthermore, the element check unit 123 stores the AND of the “E” bit and the “V” bit of the stage 1 in the “determination end” flip-flop of the stage 2.

As described above, in the present exemplary embodiment, in the values of the V bit, the S bit, and the E bit, a value representing affirmation is 1 and a value representing negation is 0. Accordingly, when the value stored in the flip-flop of the “E” and the value stored in the flip-flop of the “V” are commonly 1, the element check unit 123 stores 1 in the “determination end” flip-flop as the value. When the value stored in the flip-flop of the “V” is 1, a value based on a valid instruction has been stored in each of the flip-flops of the stage 1. When the value stored in the flip-flop of the “E” is 1, the rearmost address of a plurality of addresses to be accessed by the aforementioned object instruction is included in any one of the flip-flops form the “address 0” to the “address 3”. In this case, the value stored in the flip-flop of the “ODD” by the element check unit 123 represents whether all addresses to be accessed by the object instruction are odd addresses. The value stored in the flip-flop of the “EVEN” by the element check unit 123 represents whether all the addresses to be accessed by the object instruction are even addresses.

As described above, the values of the “ODD” and “EVEN” flip-flops of the stage 2, at timing when the “determination end” flip-flop is lighted, indicate a determination result for one valid instruction. At the timing when the value of the “determination end” flip-flop is lighted, the element check unit 123 transmits the values of the “instruction ID”, “ODD” and “EVEN” flip-flops to the overtaking determination unit 122 as an element check result.

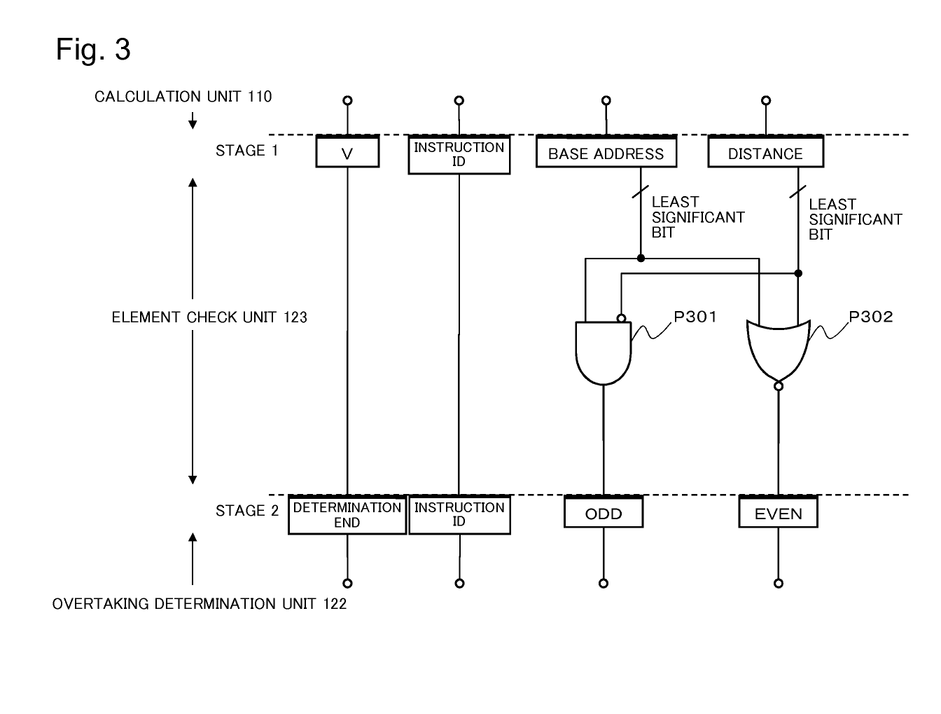

FIG. 3 is a block diagram illustrating another operation of the element check unit 123. Hereinafter, with reference to FIG. 3, a description will be provided for an operation in which the element check unit 123 performs when an instruction to operate information recorded in a memory from a certain address (a base address) at a constant interval (a distance), such as a vector load instruction and a vector store instruction, is issued. Moreover, FIG. 3 schematically illustrates a circuit that determines the presence or absence of a bias in an address to be accessed when the issued instruction is the instruction to operate information recorded in a memory from a base address at a constant interval, such as a vector load instruction and a vector store instruction. At least a part of the element check unit 123 may also be realized by the circuit schematically illustrated in FIG. 3 or a circuit that performs the same operation.

An Address included in the memory access request issued from the calculation unit 110 is stored in a “base address” flip-flop. A V bit indicating that an instruction is valid, an instruction ID that is an identifier uniquely assigned to each instruction, and a distance indicating an interval of memory addresses to be accessed, which have been issued as control information, are stored in flip-flops of “V”, “instruction ID”, and “distance” of stage 1, respectively.

In other words, the element check unit 123 stores the address, which is included in the memory access request issued from the calculation unit 110, in the “base address” flip-flop. Moreover, the element check unit 123 stores the V bit, which represents that an instruction associated with the control information is valid, in the flip-flop of the “V” of stage 1. The element check unit 123 stores the instruction ID, which is an identifier of an instruction uniquely assigned to each instruction, in the flip-flop of the “instruction ID” of stage 1. The element check unit 123 stores the distance, which indicates an interval of memory addresses to be accessed by an instruction, in the flip-flop of the “distance” of stage 1.

By calculating an AND of the least significant bit of the “base address” and negation of the least significant bit of the “distance” (processing P301), it is determined whether access destinations are only odd addresses. Then, the determination result (that is, the calculated AND) is stored in an “ODD” flip-flop of stage 2. Furthermore, by calculating a NOR of the least significant bit of the “base address” and the least significant bit of the “distance” (processing P302), it is determined whether the access destinations are only even addresses. Then, the determination result is stored in an “EVEN” flip-flop of stage 2.

In other words, the element check unit 123 calculates the AND of the least significant bit of the “base address” and the negation of the least significant bit of the “distance”. When the base address is an odd address and the distance is an even number, all addresses of the access destinations are odd addresses. Otherwise, at least one of the addresses of the access destination is an even address. When the AND of the least significant bit of the “base address” and the negation of the least significant bit of the “distance” is 1, all the addresses of the access destinations are odd addresses. When the AND of the least significant bit of the “base address” and the negation of the least significant bit of the “distance” is not 1, at least one of the addresses of the access destinations is an even address. The element check unit 123 stores the AND of the least significant bit of the “base address” and the negation of the least significant bit of the “distance” in the “ODD” flip-flop of stage 2. Furthermore, the element check unit 123 calculates the NOR of the least significant bit of the “base address” and the least significant bit of the “distance”. When the base address is an even address and the distance is an even number, all the addresses of the access destination are even addresses. Otherwise, at least one of the addresses of the access destinations is an odd address. When the NOR of the least significant bit of the “base address” and the least significant bit of the “distance” is 1, all the addresses of the access destinations are even addresses. When the NOR of the least significant bit of the “base address” and the least significant bit of the “distance” is 0, at least one of the addresses of the access destinations is an odd address. The element check unit 123 stores the NOR of the least significant bit of the “base address” and the least significant bit of the “distance” in the “EVEN” flip-flop of stage 2.

The values of the “V” bit and the “instruction ID” of the stage 1 are stored in a “determination end” flip-flop and an “instruction ID” flip-flop of the stage 2, respectively. In other words, the element check unit 123 stores the value of the “V” bit of the stage 1 in the “determination end” flip-flop of the stage 2. The element check unit 123 stores the value of the “instruction ID” of the stage 1 in the “instruction ID” flip-flop of the stage 2. At a timing at which the “determination end” flip-flop is lighted, the element check unit 123 transmits the values of the “instruction ID”, “ODD”, and “EVEN” flip-flops to the overtaking determination unit 122 as an element check result.

When the instruction issued from the calculation unit 110 is a scalar instruction, the element check unit 123 determines that access based on the instruction is access to an odd or even address on the basis of lighting or extinction of the least significant bit of the address of the access destination. That is, when the least significant bit of the address is lighted, the element check unit 123 determines that the access is access to an odd address, and when the least significant bit of the address is extinguished, the element check unit 123 determines that the access is access to an even address. Then, the element check unit 123 transmits the determination result to the overtaking determination unit 122 as an element check result.

When an instruction is issued from the calculation unit 110 as the scalar instruction, the element check unit 123 receives, for example, an address of an access destination of the scalar instruction, and control information including the V bit and the instruction ID. The element check unit 123 stores the received address in, for example, a flip-flop (not illustrated) of an “address” of the stage 1. Moreover, the element check unit 123 stores the V bit in the flip-flop of the “V” of the stage 1. The element check unit 123 stores the instruction ID in the flip-flop of the “instruction ID” of the stage 1. The flip-flops of the “V” and the “instruction ID” may be the same as the flip-flops of the “V” and the “instruction ID” of the stage 1 illustrated in FIG. 2.

For example, the element check unit 123 may store the value of the least significant bit of the address of the access destination in the aforementioned flip-flop of the “ODD”. The element check unit 123 may store negation of the value of the least significant bit of the address of the access destination in the aforementioned flip-flop of the “EVEN”. The element check unit 123 stores the value stored in the flip-flop of the “V” of the stage 1, in the flip-flop of the “determination end” of the stage 2. The element check unit 123 stores the value stored in the flip-flop of the “instruction ID” of the stage 1, in the flip-flop of the “instruction ID” of the stage 2. In this case, each of the flip-flops of the stage 2 may be the same as the flip-flops of the stage 2 illustrated in FIG. 2.

At the timing at which the “determination end” flip-flop is lighted, the element check unit 123 may transmit the values of the “instruction ID”, “ODD”, and “EVEN” flip-flops to the overtaking determination unit 122 as an element check result.

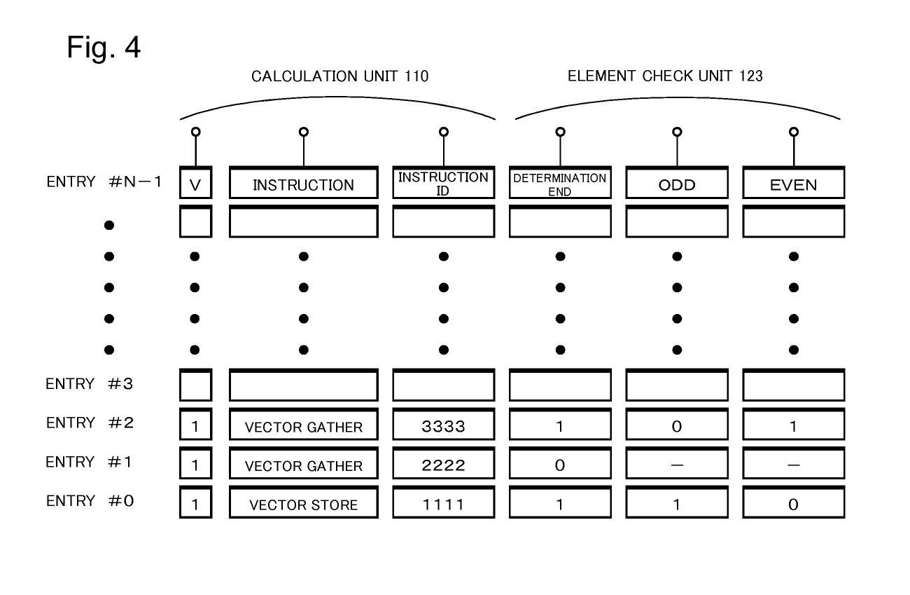

FIG. 4 is a diagram illustrating the buffer 1221 provided in the overtaking determination unit 122. The buffer 1221 is a buffer that stores the instruction issued from the calculation unit 110 and each control information item in a FIFO (First In First Out) scheme. The buffer 1221 has N entries. The entries include items of “V”, “instruction”, “instruction ID”, “determination end”, “ODD”, and “EVEN”. The buffer 1221 receives information from the upper entries of FIG. 4 and outputs information from the lower entries of FIG. 4. When any one entry is empty, the buffer 1221 has a function of filling rear entries (the upper entries in FIG. 4) in a head direction (a downward direction of FIG. 4).

The overtaking determination unit 122 registers the memory access request received from the calculation unit 110 in the buffer 1221 as a new entry. At this time, the overtaking determination unit 122 sets 1 in the item of “V” of the entry registered as the new entry. The overtaking determination unit 122 sets the instruction type and the instruction ID, which are included in the memory access request received from the calculation unit 110, in the items of “instruction” and “instruction ID” of the entry registered as the new entry, respectively. Furthermore, the overtaking determination unit 122 sets 0 in the item of “determination end” of the entry.

When the element check result is received from the element check unit 123, the overtaking determination unit 122 searches for the buffer 1221 by employing the instruction ID included in the element check result as a key. Then, the overtaking determination unit 122 detects an entry, in which an instruction ID equal to the instruction ID included in the received element check result has been set, from the buffer 1221. The overtaking determination unit 122 sets values of the ODD and the EVEN included in the received element check result in the items of “ODD” and “EVEN” of the detected entry. At this time, the overtaking determination unit 122 sets 1 in an item of “determination end” of the detected entry.

Entries #0 and #2 of FIG. 4 indicate entries for which the element check results have already received. In these entries #0 and #2, 1 is set in the item of “determination end” and 0 or 1 is set in the items of “ODD” and “EVEN”. On the other hand, entry #1 indicates an entry for which the element check result has not been received. In the entry #1, 0 is set in the item of “determination end”. Furthermore, values are not set in the items of “ODD” and “EVEN” of the entry #1. In FIG. 4, “−” written in the items of the “ODD” and the “EVEN” of the entry #1 indicates that the items are indefinite because values are not set yet.

The overtaking determination unit 122 performs arbitration in which an instruction to be issued is determined among instructions registered in an entry. The type of an instruction to be arbitrated and the type of an instruction to be preferentially issued may be determined in advance. The type of the instruction to be arbitrated and the type of the instruction to be preferentially issued are various according to an apparatus.

Hereinafter, an overtaking determination operation of the overtaking determination unit 122 will be described with reference to FIG. 4. In the present exemplary embodiment, in the following description, the overtaking determination unit 122 performs arbitration for three instructions at the head of the entries. In this arbitration, on the basis of the element check result, the overtaking determination unit 122 operates the entries such that load instructions overtake store instructions as much as possible.

In addition, a description that a bit of a certain item is lighted indicates that 1 has been set in the item. Similarly, a description that a bit of a certain item is extinguished indicates that 0 has been set in the item.

A vector store instruction that is a store instruction is registered in the entry #0 of the buffer 1221. Since a “determination end” bit and an “ODD” bit of the entry #0 are lighted, the overtaking determination unit 122 determines that the store instruction accesses only odd addresses of a memory. On the other hand, a vector gather instruction that is a load instruction is registered in the entry #1. Since a “determination end” bit of the entry #1 is extinguished, the overtaking determination unit 122 determines that determination of a bias of addresses is not performed because an element check result is not transmitted yet for the load instruction. Accordingly, the overtaking determination unit 122 determines that the load instruction of the entry #1 cannot overtake the store instruction of the entry #0.

Moreover, a vector gather instruction is also registered in the entry #2. Since a “determination end” bit and an “EVEN” bit of the entry #2 are lighted, the overtaking determination unit 122 determines that the load instruction accesses only even addresses of a memory. When addresses to be accessed by the store instruction are all odd address and addresses to be accessed by the load instruction are all even address, access destinations of the store instruction and the load instruction do not overlap each other. Similarly, when addresses to be accessed by the store instruction are all even address and addresses to be accessed by the load instruction are all odd address, the access destinations of the store instruction and the load instruction do not overlap each other. In other cases, it is probable that the access destinations of the store instruction and the load instruction overlap each other. In the aforementioned example, since the access destinations of the store instruction of the entry #0 and the load instruction of the entry #2 do not overlap each other, the overtaking determination unit 122 determines that the load instruction of the entry #2 can overtake the store instruction of the entry #0. Furthermore, the overtaking determination unit 122 determines that the load instruction of the entry #2 can overtake the load instruction of the entry #1 that is the load instruction similarly.

Finally, the overtaking determination unit 122 determines that the vector gather instruction of the entry #2 is an instruction that should overtake the instructions of the entries #0 and #1 and should be initially executed. Then, the overtaking determination unit 122 transmits 3333, which is a value of the item of the “instruction ID” of the entry #2, to the overtaking processing unit 121 as an issue indication.

As described above, the overtaking determination unit 122 confirms a bias of addresses of access destinations indicated by the element check result in a preceding store instruction and a subsequent load instruction. On the confirmed bias of the addresses, the overtaking determination unit 122 determines whether access destinations of these instructions overlap each other. Then, when the access destinations of these instructions do not overlap each other, the overtaking determination unit 122 determines that the subsequent load instruction can overtake the preceding store instruction and can be executed. In detail, the overtaking determination unit 122 confirms lighting of “determination end” bits of the preceding store instruction and the subsequent load instruction and the present or absence of a bias of addresses of access destinations indicated by “ODD” and “EVEN” bits of the preceding store instruction and the subsequent load instruction. When the “determination end” bits of these instructions are lighted and the “ODD” bit of one instruction and the “EVEN” bit of the other instruction are lighted, the overtaking determination unit 122 determines that the access destinations of these instructions do not overlap each other. When the access destinations do not overlap each other and an instruction not be overtaken by the subsequent load instruction does not exist between these instructions, the overtaking determination unit 122 determines that the subsequent load instruction can overtake the preceding store instruction and can be executed. In addition, the instruction not be overtaken, for example, is a store instruction in which in an “ODD” or “EVEN” bit, a bit equal to that of the subsequent load instruction is lighted, or a “determination end” bit is extinguished.

The overtaking processing unit 121 temporarily stores the memory access request issued from the calculation unit 110. Then, on the basis of the issue indication received from the overtaking determination unit 122, the overtaking processing unit 121 issues a memory access request related to an instruction ID included in the issue indication toward the memory access issue unit 125. When an instruction to be issued is an instruction to perform the list access, the overtaking processing unit 121 transmits information (that is, the aforementioned memory access request information) on the memory access request, such as an instruction ID, to the list address buffer 124. On the basis of the received memory access request information, the list address buffer 124 issues a list address associated with the issued memory access request toward the memory access issue unit 125. On the basis of the received memory access request, the memory access issue unit 125 accesses a memory.

As described above, in the CPU 100 according to the first exemplary embodiment of the present invention, it is possible to improve the frequency by which the overtaking processing is performed. This is because the element check unit 123 determines biases of addresses of access destinations of memory access instructions and determines whether to perform the overtaking process on the basis of the biases determined by the overtaking determination unit 122.

Furthermore, in the CPU 100 according to the first exemplary embodiment of the present invention, even when the overtaking processing is actually possible but is determined not to be possible in the technology disclosed in Patent Literature 1 or 2, it is possible to correctly determine whether to perform the overtaking processing. In detail, even when a subsequent load instruction accesses a memory of accesses between a maximum address and a minimum address, which is accessed by a preceding store instruction that performs vector access, it is possible to correctly determine whether to perform the overtaking processing. Consequently, in the CPU 100 according to the first exemplary embodiment of the present invention, the overtaking processing is realized in many more access patterns as compared with the technology disclosed in Patent Literature 1 or 2. Thus, in the CPU 100 according to the present exemplary embodiment, it is possible to improve memory access performance.

### Second Exemplary Embodiment

Next, a second exemplary embodiment of the present invention will be described. In the following description, the same reference numerals are used to designate the same elements as those of the first exemplary embodiment, and a redundant description will be omitted.

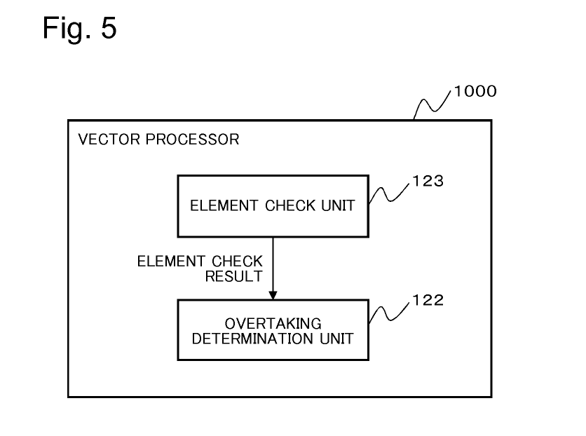

FIG. 5 is a block structure diagram illustrating a structure of a vector processor according to a second exemplary embodiment of the present invention. A vector processor 1000 according to the second exemplary embodiment of the present invention includes an element check unit 123 and an overtaking determination unit 122.

The element check unit 123 calculates the state of bits of a preset number of digits from the least significant digit of an address of a memory, which is accessed by a load instruction or a store instruction, as an element check result.

The overtaking determination unit 122 performs overtaking determination of the load instruction for the store instruction preceding the load instruction on the basis of the element check result.

As described above, in the vector processor 1000 according to the second exemplary embodiment of the present invention, it is possible to increase the frequency by which the overtaking process is performed. This is because the element check unit 123 calculates a bias of addresses of access destinations of the load instruction or the store instruction as an element check result, and the overtaking determination unit 122 determines whether to perform the overtaking process on the basis of the element check result.

The element check unit 123 of the first exemplary embodiment calculates the state of the least significant bit of addresses and determines whether access destinations are odd addresses or even addresses. However, the state of bits other than the least significant bit may be specified as described above. For example, the element check unit 123 may specify the state of lower 2 bits of an address, and determine biases of addresses of access destinations. In this case, the element check unit 123 may determine whether the lower 2 bits of the addresses of the access destinations are any one of “00”, “01”, “10”, and “11”. The element check unit 123 may specify a bit pattern taken by the lower 2 bits of the addresses of the access destinations among “00”, “01”, “10”, and “11”. Then, the element check unit 123 may output the bit pattern taken by the lower 2 bits of the addresses of the access destinations as an element check result. Then, on the basis of element check results regarding a preceding store instruction and a subsequent load instruction, the overtaking determination unit 122 may perform overtaking determination. Alternatively, the element check unit 123 may calculate the state of lower bits having a bit number of three bits or more set in advance.

In other words, the element check unit 123 may specify a bit pattern, which may be lower N bits of addresses (that is, object addresses) of access destinations of an instruction that accesses a memory, among bit patterns of a preset number of digits (for example, N bits). In this case, N is equal to or more than 1, and is an integer equal to or less than a number which may be a bit length of the object addresses of the instruction. Then, the element check unit 123 may specify a set of bit patterns, which may be lower N bits of the object addresses of the instruction, as the state of the lower N bits of the object addresses of the instruction.

On the basis of the state of lower N bits of object addresses of two instructions, the overtaking determination unit 122 may perform overtaking determination of the two instructions. In detail, the overtaking determination unit 122 may detect a common bit pattern between a set of bit patterns specified for a first instruction (for example, a load instruction) and a set of bit patterns specified for a second instruction (for example, a store instruction). When a common bit pattern is not detected, the overtaking determination unit 122 may determine that overtaking is possible between the first instruction and the second instruction. In this case, for example, when an entry of the second instruction is positioned after an entry of the first instruction, the overtaking determination unit 122 may determine that the second instruction can overtake the first instruction.

An example of an operation of determining biases of addresses of access destinations by the state of lower 2 bits of addresses will be described. It is assumed that the element check unit 123 determines that a list address included in a certain vector store instruction includes, for example, only addresses in which the values of lower 2 bits are “01”, “10”, and “11”. When the values of lower 2 bits of addresses of access destinations of a load instruction subsequent to the vector store instruction are only “00”, the overtaking determination unit 122 determines that the load instruction can overtake the vector store instruction. When the values of lower 2 bits of addresses of access destinations of a load instruction subsequent to the vector store instruction includes a value other than “00”, the overtaking determination unit 122 determines that the load instruction cannot overtake the vector store instruction.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A vector processor comprising:
an element check unit that calculates a state of bits of a preset number of digits from a least significant digit of an address of a memory, which is accessed by a load instruction or a store instruction, as an element check result; and
an overtaking determination unit that performs overtaking determination of a load instruction for a store instruction preceding to the load instruction on a basis of the element check result.

2. The vector processor according to claim 1, wherein
the load instruction or the store instruction is an instruction that performs access by a list address, and
the element check unit calculates the element check result by calculating a state of bits of a preset number of digits from a least significant digit of the list address.

3. The vector processor according to claim 1, wherein
the load instruction or the store instruction is an instruction that performs access at a specific interval from a specific address, and
the element check unit calculates the element check result on a basis of a state of bits of a preset number of digits from a least significant digit of the specific address and a state of bits of a preset number of digits from a least significant digit of a value of the specific interval.

4. The vector processor according to claim 1, wherein
the preset number of digits is 1, and
the element check unit calculates, as the element check result, whether the address of the memory to be accessed by the load instruction or the store instruction is only an odd address or only an even address.

5. An information processing apparatus including the vector processor according to claim 1, comprising:
the memory.

6. An overtaking control method comprising:
calculating a state of bits of a preset number of digits from a least significant digit of an address of a memory, which is accessed by a load instruction or a store instruction, as an element check result; and
performing overtaking determination of a load instruction for a store instruction preceding to the load instruction on a basis of the element check result.

7. The overtaking control method according to claim 6, wherein
the load instruction or the store instruction is an instruction that performs access by a list address, and
the element check result is calculated by calculating a state of bits of a preset number of digits from a least significant digit of the list address.

8. The overtaking control method according to claim 6, wherein
the load instruction or the store instruction is an instruction that performs access at a specific interval from a specific address, and
the element check result is calculated on a basis of a state of bits of a preset number of digits from a least significant digit of the specific address and a state of bits of a preset number of digits from a least significant digit of a value of the specific interval.

9. The overtaking control method according to claim 6, wherein
the preset number of digits is 1, and
whether the address of the memory to be accessed by the load instruction or the store instruction is only an odd address or only an even address are calculated as the element check result.
